(19) United States
(12) Patent Application Publication
(10) Pub. No.: US 2007/0296770 A1
(43) Pub. Date: Dec. 27, 2007

(54) Apparatus for ejecting ink, a fabrication method thereof, and ink cartridge having the apparatus for ejecting ink

(75) Inventors: Jae-cheol Lee, Hwaseong-si (KR); Myung-song Jung, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/649,842

(22) Filed: Jan. 5, 2007

(30) Foreign Application Priority Data
Jun. 22, 2006 (KR) 10-2006-0056351

(51) Int. Cl. B41J 2/05

(52) U.S. Cl. 347/66

(57) ABSTRACT

An apparatus for ejecting ink which can smoothly guide flow of ink, a method of fabricating the same, and an ink cartridge having the apparatus for ejecting ink are disclosed. The apparatus includes a channel unit having at least one supplying channel, and a print head having at least one nozzle and at least one supplying passage. The print head is adhered to the channel unit so that the supplying passage communicates with the supplying channel. At least one glue receiving groove is formed at a location in which the print head and the channel unit are adhered to each other.

### CROSS-REFERENCE TO RELATED APPLICATION

This application claims the benefit under 35 U.S.C. § 119(a) of Korean Patent Application No. 10-2006-56351, filed Jun. 22, 2006, in the Korean Intellectual Property Office, the entire disclosure of which is hereby incorporated by reference.

### BACKGROUND OF THE INVENTION

1. Field of the Invention

The present invention relates to an apparatus for ejecting ink. More particularly, the present invention relates to an apparatus for ejecting ink, a fabrication method thereof, and an ink cartridge having the apparatus for ejecting the ink.

2. Description of the Related Art

An inkjet printer is an apparatus that ejects droplets of ink for printing onto a recording medium, such as printing paper or fabric, to form a desired image, and typically includes an ink cartridge. The ink cartridge has an ink tank that contains ink and an ink ejecting apparatus that ejects the ink onto the recording medium.

Referring to FIG. 1, a conventional ink ejecting apparatus includes a print head 30 and a channel unit 17. The print head 30 is provided with a substrate 31 that has at least one supplying passage 31a that communicates with at least one supplying channel 17a, at least one ink chamber 32 that is filled with ink, and at least one nozzle 33 that communicates with the at least one ink chamber 32. If the print head 30 is a thermal driving type head, a heater is disposed in the ink chamber 32. If the print head 30 is a piezoelectric driving type head, a piezoelectric element is disposed in the ink chamber 32.

In the ink ejecting apparatus described above, the print head 30 is adhered to the channel unit 17 by an adhesive, such as glue or a sealant, so that the supplying passage 31a of the print head 30 communicates with the supplying channel 17a of the channel unit 17.

A typical method of adhering the print head 30 to the channel unit 17 will now be described, with reference to FIGS. 2A and 2B. As illustrated in FIG. 2A, a glue S is applied to the print head 30 and/or the channel unit 17. At this time, the glue S is applied between the supplying passage 31a of the print head 30 and the supplying channel 17a of the channel unit 17.

Subsequently, as illustrated in FIG. 2B, the print head 30 is pushed down against the channel unit 17 with a high pressure, and is cured at a predetermined temperature for a predetermined time. As a result, the print head 30 is securely adhered to the channel unit 17.

To apply the glue S in the form of liquid at an accurate position between the print head 30 and the channel unit 17 (that is, between the supplying passage 31a and the supplying channel 17a), an ink cartridge having the ink ejecting apparatus described above requires a glue S with a relatively high viscosity. Accordingly, the ink cartridge is disadvantageous in that a glue dispenser for dispensing the glue requires a high dispensing pressure, and because the print head 30 is pushed down against the cartridge with the high pressure, it is possible to damage the print head 30.

Also, if a high viscosity glue is used, the print head 30 may slip while being pushed down with high pressure to adhere it to the cartridge. In this case, it is difficult to adhere the print head 30 to the channel unit 17 at an accurate position. If a plurality of print heads 30 are adhered to the cartridge (as in an array type print head), it is particularly difficult to secure the precise position and spacing (for example, within a range of approximately ±5 μm) among adjacent nozzles between the print heads 30.

Furthermore, when the print head 30 is pushed down against the cartridge, portions L of the glue S may flow into the supplying passage 31a of the print head 30 and/or the supplying channel 17a of the channel unit 17 due to the applied pressure. In this case, the width of the supplying passage 31a and/or the supplying channel 17a is narrowed, so that ink is not smoothly supplied to the nozzle 33 and the negative pressure in the supplying passage 31a and/or the supplying channel 17a is increased. The increased negative pressure damages or destroys the ink meniscus and causes external air to flow into the nozzle 33. This external air may not be completely discharged due to the portions L of the glue S in the supplying passage 31a, and may completely block the supplying passage 31a and/or the supplying channel 17a. This further hampers the ability of the nozzle 33 to smoothly eject ink.

Also, in an ink cartridge with a plurality of nozzles 33 used for printing different color inks, the distance between adjacent supplying passages 31a and adjacent supplying channels 17a is typically very short. If there are any voids in the glue S along along the portions B of the ink cartridge (see FIG. 1), a different color ink in one supplying passage 31a and/or one supplying channel 17a may easily pass into another supplying passages 31a and/or other supplying channels 17a, thereby resulting in a color mixing of the ink.

Accordingly, there is a need for an improved apparatus for ejecting ink that does not introduce obstacles into the ink path, a method of fabrication for the same, and an image forming apparatus using the same.

### SUMMARY OF THE INVENTION

An aspect of the present invention is to address at least the above problems and/or disadvantages and to provide at least the advantages described below. Accordingly, an aspect of the present invention is to provide an apparatus for ejecting ink, which can prevent the generation of obstacle in an ink supplying path, thereby allowing the ink to be more smoothly ejected, a fabrication method thereof, and an ink cartridge having the apparatus for ejecting the ink.

Another aspect of the present invention is to provide an apparatus for ejecting ink that enables a print head to be adhered at an accurate position, a fabrication method thereof, and an ink cartridge having the apparatus for ejecting the ink.

Yet another aspect of the present invention is to provide an apparatus for ejecting ink in which a plurality of supplying passages and/or supplying channels are configured so that they minimize infiltration of different color ink, thereby preventing mixing of the color ink, a fabrication method thereof, and an ink cartridge having the apparatus for ejecting the ink.

According to an aspect of an exemplary embodiment of the present invention, an apparatus for ejecting ink includes a channel unit having at least one supplying channel and a print head having at least one nozzle and at least one supplying passage. The print head is adhered to a side of the channel unit so that the supplying passage communicates with the supplying channel. At least one glue receiving groove is formed where the print head and the channel unit are adhered to each other.

The glue receiving groove may be formed on an adhering surface of the channel unit.

If the channel unit has a plurality of supplying channels, a plurality of glue receiving grooves may be formed between the supplying channels, respectively.

The glue receiving groove may be formed on an adhering surface of the print head.

If the print head has a plurality of supplying passages, a plurality of glue receiving grooves may be formed between the supplying passages, respectively.

The glue receiving groove may be formed on at least one of an adhering surface of the print head and an adhering surface of the channel unit.

A plurality of glue receiving grooves may be formed between a plurality of supplying passages and between a plurality of supplying channels, respectively.

According to another aspect of an exemplary embodiment of the present invention, an ink cartridge includes a cartridge body having an ink tank, a channel unit having at least one supplying channel to communicate with the ink tank, and a print head having at least one nozzle and at least one supplying passage. The print head is adhered to a side of the channel unit so that the supplying passage communicates with the supplying channel. At least one glue receiving groove is formed where the print head and the channel unit are adhered to each other.

The glue receiving groove may be formed on an adhering surface of the channel unit.

If the channel unit has a plurality of supplying channels, a plurality of glue receiving grooves may be formed between the supplying channels, respectively.

The glue receiving groove may be formed on an adhering surface of the print head.

If the print head has a plurality of supplying passages, a plurality of glue receiving grooves may be formed between the supplying passages, respectively.

The glue receiving groove may be formed on both an adhering surface of the print head and an adhering surface of the channel unit.

A plurality of glue receiving grooves may be formed between a plurality of supplying passages and between a plurality of supplying channels, respectively.

According to another aspect of an exemplary embodiment of the present invention, a method of fabricating an apparatus for ejecting ink includes forming at least one glue receiving groove at a location where a print head and a channel unit are adhered to each other, before adhering the print head to the channel unit. The print head has at least one nozzle and at least one supplying passage, and the channel unit has at least one supplying channel.

The glue receiving groove may be formed on an adhering surface of the channel unit by a molding process.

The glue receiving groove may be formed on an adhering surface of the print head by an etching process.

According to another aspect of an exemplary embodiment of the present invention, a method of assembling a print head having an ink supplying passage to an ink cartridge having a supplying channel comprises forming a glue receiving groove on one of the print head or the ink cartridge, applying adhesive to the glue receiving groove, and pressing the print head to the ink cartridge so that the supplying channel and the supplying passage are aligned.

The glue receiving groove may be formed on an adhering surface of the ink cartridge.

The glue receiving groove may be formed on an adhering surface of the print head.

Glue receiving grooves may be formed on adhering surfaces of both of the print head and the ink cartridge.

In the step of pressing the print head to the ink cartridge, no obstructions may be formed in the supplying channel and the supplying passage by glue.

According to another aspect of an exemplary embodiment of the present invention, an ink cartridge comprises a cartridge body having an ink tank for storing ink and a supplying channel in fluid communication with the ink tank, a print head having a supplying passage for receiving ink from the supplying channel, the print head being glued to the cartridge body, and at least one glue receiving groove disposed at a location where the print head and the channel unit are glued to each other.

The supplying passage and the supplying channel may have no obstructions from glue.

The glue receiving groove may be formed on an adhering surface of the ink cartridge.

The glue receiving groove may be formed on an adhering surface of the print head.

Glue receiving grooves may be formed on adhering surfaces of both of the print head and the ink cartridge.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a cross sectional view of a conventional apparatus for ejecting ink;

FIGS. 2A and 2B are cross sectional views of a process for fabricating the apparatus for ejecting ink of FIG. 1;

FIG. 3 is a cross sectional view of an ink cartridge in accordance with an exemplary embodiment of the present invention;

FIG. 4 is a cross sectional view of an apparatus for ejecting ink taken along line IV-IV of FIG. 3;

FIGS. 5A through 5C are cross sectional views of a process for fabricating the apparatus for ejecting ink illustrated in FIG. 3;

FIG. 6 is a cross-sectional view of an apparatus for ejecting ink according to another exemplary embodiment of the present invention; and

FIG. 7 is a cross-sectional view of an apparatus for ejecting ink according to another exemplary embodiment of the present invention.

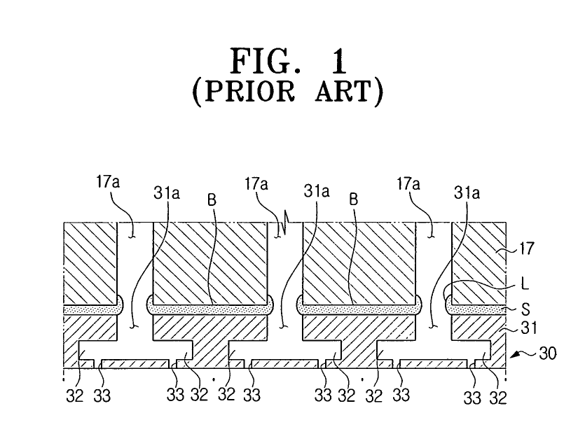

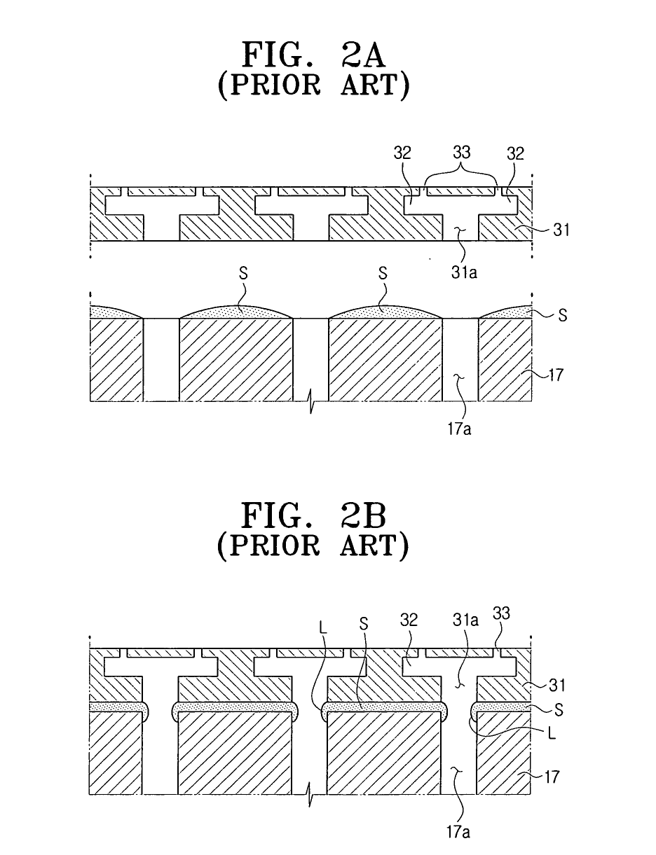

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

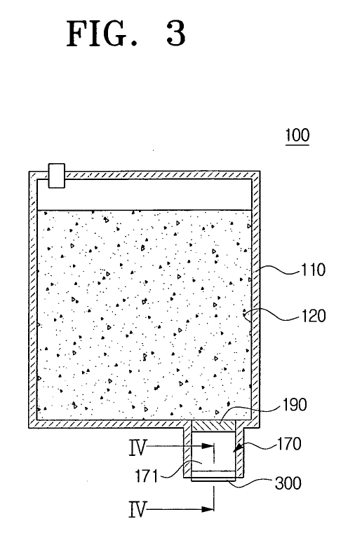

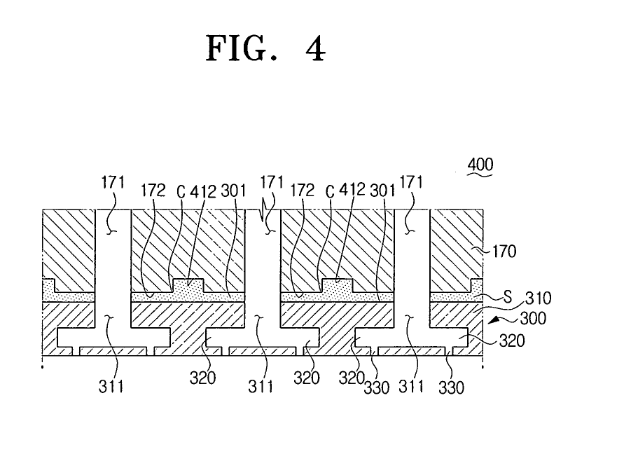

Referring to FIGS. 3 and 4, an ink cartridge 100 in accordance with an exemplary embodiment of the present invention includes a cartridge body 110, an ink tank 120, a channel unit 170, and at least one print head 300.

The ink tank 120 is formed in the cartridge body 110, and typically contains foam and ink. The channel unit 170 supplies the ink in the ink tank 120 to the print head 300. A filter 190 is disposed on the top of the channel unit 170. The filter 190 filters the ink supplied to the print head 300 from the ink tank 120. The print head 300 is disposed on the cartridge body 110 to eject ink.

The ink tank 120 can be configured so that it has a single space filled with the ink and the foam. Alternatively, it can be divided into an ink containing space filled with ink and a foam containing space filled with foam. The ink tank 120 can also contain and store ink without foam.

The channel unit 170 is either detachably connected to the cartridge body 110 or integrally formed with the cartridge body 110. The channel unit 170 has at least one supplying channel 171 to supply ink stored in the ink tank 120 to the print head 300.

The print head 300 includes a substrate 310, at least one ink chamber 320, and at least one nozzle 330. At least one supplying passage 311 which communicates with at least one supplying channel 171 is formed on the substrate 310. The ink chamber 320 communicates with the supplying passage 311 and is filled with ink. The nozzle 330 communicates with the ink chamber 320.

The print head 300 can be any type of print head, such as a thermal driving type head, a piezoelectric driving type head, or the like. A thermal driving type head uses heat generated from a heating source, such as a heater or the like, to produce bubbles in ink and eject the ink by an expansive force of the bubbles. The piezoelectric driving type head uses a piezoelectric element to eject ink by distorting the piezoelectric element.

FIG. 4 is a cross sectional view through a portion of the ink cartridge 100 that illustrates an ink ejecting apparatus 400 including the print head 300 and the channel unit 170.

The print head 300 is adhered to a side of the channel unit 170 by an adhesive, such as glue. At least one glue receiving groove 412 is formed on the surfaces 301 and 172 on which the print head 300 and the channel unit 170 are adhered to each other.

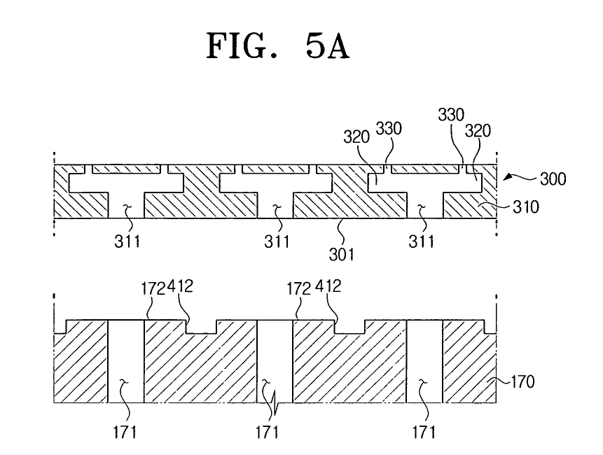

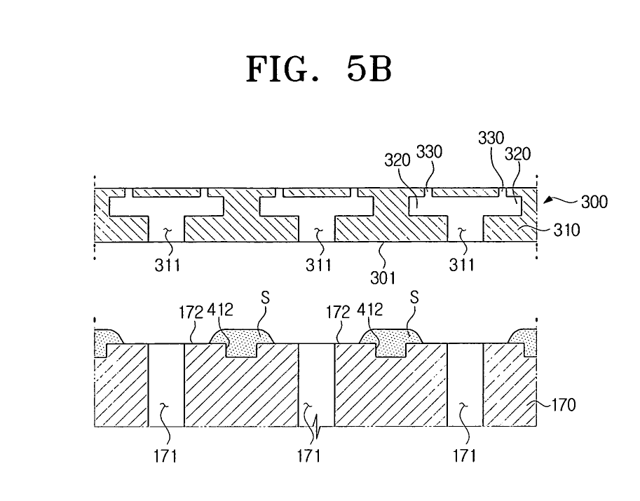

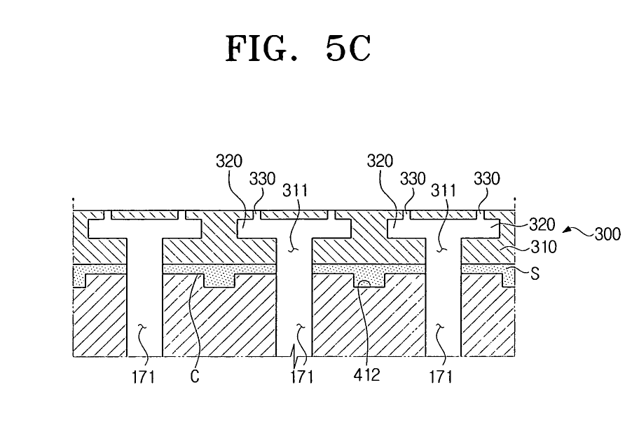

As illustrated in FIG. 4 and FIGS. 5A through 5C, according to an exemplary embodiment of the present invention, the glue receiving groove 412 is formed on an adhering surface 172 of the channel unit 170. If the channel unit 170 has a plurality of supplying channels 171, a plurality of glue receiving grooves 412 are formed on the adhering surfaces 172 between the supplying channels 171.

It should be noted that although one glue receiving groove 412 is illustrated and explained as formed on the adhering surface 172 between one supplying channel 171 and one supplying channel 171, the present invention is not limited to this particular configuration. Other configurations are also possible. For instance, a plurality of glue receiving grooves 412 can be formed on the adhering surface 172 between one supplying channel 171 and one supplying channel 171.

In the exemplary embodiments of the present invention, the glue receiving groove 412 is integrally formed with the channel unit 170 during the process of forming the channel unit 170 from a synthetic resin.

As illustrated in FIG. 5B, when glue S is applied on the adhering surface 172 of the channel unit 170, it is guided to enter the glue receiving groove 412, and thus evenly coated centering on the glue receiving groove 412.

Then, the print head 300 is pushed down against the channel unit 170 with an appropriate pressure, and cured at a predetermined temperature for a predetermined time. As a result, as illustrated in FIG. 5C, the print head 300 is adhered to the channel unit 170. At this time, the supplying passage 311 of the print head 300 and the supplying channel 171 communicate with each other.

With this constructions, the glue S is guided to enter the glue receiving groove 412. Accordingly, the ink ejecting apparatus 400 according to the first exemplary embodiment of the present invention prevents the glue S from leaking into the supplying channel 171 and/or the supplying passage 311, thereby preventing restrictions from forming in the supplying channel 171 and/or the supplying passage 311. Thus, the ink ejecting apparatus 400 according to the exemplary embodiments of the present invention can more smoothly supply ink to the nozzle 330 and more easily eject ink through the nozzle 330.

Also, the glue receiving groove 412 of the ink ejecting apparatus 400 accommodates excess glue S, thereby allowing more tolerance in the amount of the glue S applied.

Moreover, the glue receiving groove 412 holds the glue, thereby correcting for slight errors that occur while applying the glue S. Accordingly, the ink ejecting apparatus 400 according to the exemplary embodiments of the present invention do not require precise accuracy when applying the glue S. This allows the use of a relatively low viscosity glue (as compared with that of the glue in the conventional ink ejecting apparatus) and allows the glue to be evenly applied.

As described above, with the glue receiving groove 412, glue S with a relatively low viscosity can be used. Accordingly, the ink ejecting apparatus 400 according to the exemplary embodiments of the present invention allows the print head 300 to be pressed against the channel unit 170 with a relatively low pressure (as compared with the conventional ink ejecting apparatus), thereby reducing the possibility of damage during the manufacture of the print head 300.

Furthermore, because the print head 300 is pushed down with a relatively low pressure, the print head 300 slips less during assembly so that it can be adhered in a more accurate position. In particular, even if a plurality of print heads 300 are adhered to the channel unit 170 as in an array type head, a precise position and a distance (for example, within a range of approximately ±5 μm) between adjacent nozzles of print heads 300 can be secured.

If the ink ejecting apparatus 400 according to the first exemplary embodiment of the present invention is applied to an ink cartridge having a plurality of nozzles 330, each of which ejects a different colored ink, the length of the portions C of the channel unit 170 adhered by the glue S is longer due to the glue receiving groove 412 as compared with a conventional ink ejecting apparatus. Thus, the ink ejecting apparatus 400 according to the exemplary embodiments of the present invention can minimize infiltration of different colored inks from one supplying passage 311 into other supplying passages 311, thereby preventing a color mixing of the ink.

And, because the area adhered by the glue S is enlarged due to the glue receiving groove 412, the ink ejecting apparatus 400 according to exemplary embodiments of the present invention can more strongly adhere the print head 300 and the channel unit 170 to each other.

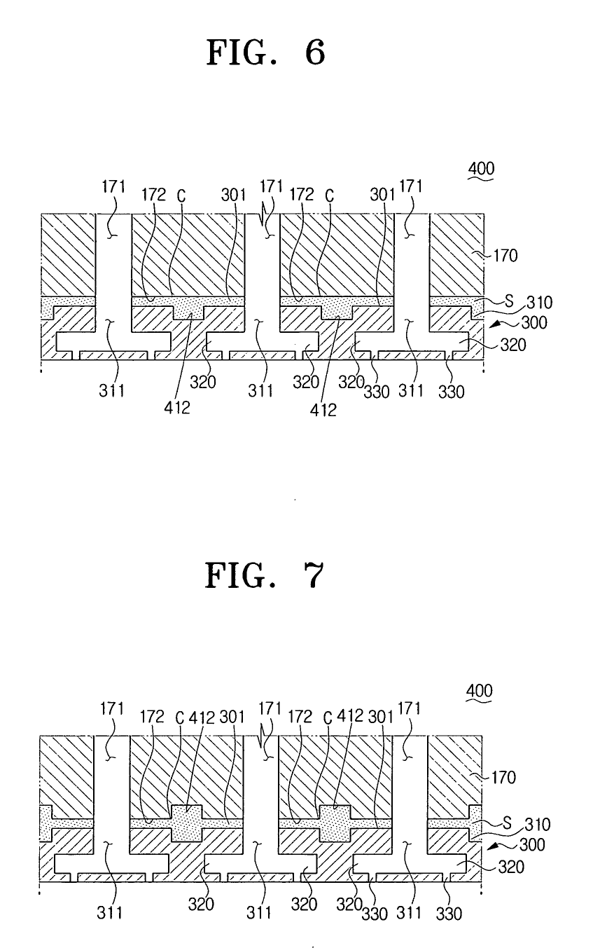

In an ink ejecting apparatus according to another exemplary embodiment of the present invention illustrated in FIG. 6, the glue receiving groove 412 is formed on an adhering surface 301 of a print head 300. If the ink ejecting apparatus has a plurality of supplying passages 311, a plurality of glue receiving grooves are formed on the adhering surfaces 301 between the supplying passages 311.

In this exemplary embodiment of the present invention, the glue receiving groove 412 can be formed on the adhering surface 301 of a print head 300 by an etching process.

In an ink ejecting apparatus according to another exemplary embodiment of the present invention illustrated in FIG. 7, a glue receiving groove 412 is formed on both an adhering surface 301 of a print head 300 and an adhering surface 172 of the channel unit 170. If the ink ejecting apparatus has a plurality of supplying channel 171 and a plurality of supplying passages 311, a plurality of glue receiving grooves are formed on the adhering surfaces 172 between the supplying channels 171 and on the adhering surfaces 301 between the supplying passages 311.

A method of fabricating an ink ejecting apparatus in accordance with the exemplary embodiments of the present invention constructed as above will now be described. First, at least one glue receiving groove 412 is formed on any one of, or both the adhering surface 301 of the print head 300 and the adhering surface 172 of the channel unit 170. Subsequently, glue S is applied between the adhering surface 301 of the print head 300 and the adhering surface 172 of the channel unit 170. Then, the print head 300 is pushed down and adhered to the channel unit 170.

As is apparent from the foregoing description, according to the exemplary embodiments of the present invention, the ink ejecting apparatus, the method of fabricating the ink ejecting apparatus, and the ink cartridge having the ink ejecting apparatus can prevent restrictions from being formed on the ink supplying path, thereby allowing ink to be more smoothly ejected.

Also, according to the exemplary embodiments of the present invention, the ink ejecting apparatus, the method of fabricating the ink ejecting apparatus, and the ink cartridge having the ink ejecting apparatus can adhere the print head in a more accurate position.

Also, according to the exemplary embodiments of the present invention, the ink ejecting apparatus, the method of fabricating the ink ejecting apparatus, and the ink cartridge having the ink ejecting apparatus minimizes the infiltration of different colored ink, thereby preventing the color mixing of the ink.

While the invention has been shown and described with reference to certain embodiments thereof, it will be understood by those skilled in the art that various changes in form and details may be made therein without departing from the spirit and scope of the invention as defined by the appended claims.

What is claimed is:

1. An apparatus for ejecting ink comprising:
a channel unit having at least one supplying channel;
a print head having at least one nozzle and at least one supplying passage, the print head being adhered to the channel unit so that the supplying passage communicates with the supplying channel; and
at least one glue receiving groove disposed where the print head and the channel unit are adhered to each other.

2. The apparatus of claim 1, wherein the glue receiving groove is disposed on an adhering surface of the channel unit.

3. The apparatus of claim 2, wherein the channel unit comprises a plurality of supplying channels and a plurality of glue receiving grooves disposed between the supplying channels.

4. The apparatus of claim 1, wherein the glue receiving groove is disposed on an adhering surface of the print head.

5. The apparatus of claim 4, wherein the print head comprises a plurality of supplying passages and a plurality of glue receiving grooves disposed between the supplying passages.

6. The apparatus of claim 1, wherein glue receiving grooves are disposed on both an adhering surface of the print head and an adhering surface of the channel unit.

7. The apparatus of claim 6, wherein a plurality of glue receiving grooves are disposed between a plurality of supplying passages and between a plurality of supplying channels.

8. An ink cartridge comprising:
a cartridge body having an ink tank:
a channel unit having at least one supplying channel that communicates with the ink tank;
a print head having at least one nozzle and at least one supplying passage, the print head being adhered to a side of the channel unit, so that the supplying passage communicates with the supplying channel; and
at least one glue receiving groove disposed at a location where the print head and the channel unit are adhered to each other.

9. The ink cartridge of claim 8, wherein the glue receiving groove is disposed on an adhering surface of the channel unit.

10. The ink cartridge of claim 9, wherein the channel unit comprises a plurality of supplying channels and a plurality of glue receiving grooves are formed between the supplying channels.

11. The ink cartridge of claim 8, wherein the glue receiving groove is disposed on an adhering surface of the print head.

12. The ink cartridge of claim 11, wherein the print head comprises a plurality of supplying passages and a plurality of glue receiving grooves formed between the supplying passages.

13. The ink cartridge of claim 8, wherein glue receiving grooves are formed on both an adhering surface of the print head and an adhering surface of the channel unit.

14. The ink cartridge of claim 13, wherein a plurality of glue receiving grooves are disposed between a plurality of supplying passages and between a plurality of supplying channels.

15. A method of fabricating an apparatus for ejecting ink, the method comprising:
adhering a print head having at least one nozzle and at least one supplying passage to a channel unit having at least one supplying channel; and
forming at least one glue receiving groove at a location where the print head and the channel unit are adhered to each other.

16. The method of claim 15, wherein the glue receiving groove is formed on an adhering surface of the channel unit by a molding process.

17. The method of claim 15, wherein the glue receiving groove is formed on an adhering surface of the print head by an etching process.

18. A method of assembling a print head having an ink supplying passage to an ink cartridge having a supplying channel, the method comprising:
forming a glue receiving groove on one of the print head or the ink cartridge;
applying adhesive to the glue receiving groove; and
pressing the print head to the ink cartridge so that the supplying channel and the supplying passage are aligned.

19. The method of claim 18, wherein the glue receiving groove is formed on an adhering surface of the ink cartridge.

20. The method of claim 18, wherein the glue receiving groove is formed on an adhering surface of the print head.

21. The method of claim 18, wherein glue receiving grooves are formed on adhering surfaces of both of the print head and the ink cartridge.

22. The method of claim 18, wherein in the step of pressing the print head to the ink cartridge, no obstructions are formed in the supplying channel and the supplying passage by glue.

23. An ink cartridge comprising:
a cartridge body having an ink tank for storing ink and a supplying channel in fluid communication with the ink tank;
a print head having a supplying passage for receiving ink from the supplying channel, the print head being glued to the cartridge body; and
at least one glue receiving groove disposed at a location where the print head and the channel unit are glued to each other.

24. The ink cartridge of claim 23, wherein the supplying passage and the supplying channel have no obstructions from glue.

25. The ink cartridge of claim 23, wherein the glue receiving groove is formed on an adhering surface of the ink cartridge.

26. The ink cartridge of claim 23, wherein the glue receiving groove is formed on an adhering surface of the print head.

27. The ink cartridge of claim 23, wherein glue receiving grooves are formed on adhering surfaces of both of the print head and the ink cartridge.
